(19) United States
(12) Patent Application Publication
(10) Pub. No.: US 2026/0366735 A1
(43) Pub. Date: Nov. 19, 2026

(54) COOKING APPARATUS

(71) Applicant: SAMSUNG ELECTRONICS CO., LTD., Suwon-si (KR)

(72) Inventors: Yujeub HA, Suwon-si (KR); Wonoo KO, Suwon-si (KR); Heesup KIM, Suwon-si (KR)

(73) Assignee: SAMSUNG ELECTRONICS CO., LTD., Suwon-si (KR)

(21) Appl. No.: 19/741,391

(22) Filed: Jul. 14, 2026

Related U.S. Application Data
(63) Continuation of application No. PCT/KR2024/018204, filed on Nov. 19, 2024.

(30) Foreign Application Priority Data
Feb. 22, 2024 (KR) 10-2024-0026101

(51) Int. Cl. F24C 15/20; H05B 6/12

(52) U.S. Cl. CPC F24C 15/2042; H05B 6/12

(57) ABSTRACT

A cooking apparatus enabled to minimize a step with an upper plate by improving an assembly structure of a hood. The cooking apparatus includes a plate including an intake port, an opening/closing device to be disposed below the plate and configured to move a cover movably provided to cover or open the intake port, and a holder including an adhesive portion to be between the opening/closing device and the plate such that while the holder is between the opening/closing device and the plate, the adhesive portion is adhered to a bottom surface of the plate.

### CROSS-REFERENCE TO RELATED APPLICATION

This application is a continuation application, under 35 U.S.C. §111(a), of international application No. PCT/KR2024/018204, filed Nov. 19, 2024, which claims priority under 35 U.S.C. §119 to Korean Patent Application No. 10-2024-0026101, filed Feb. 22, 2024, the disclosures of which are incorporated herein by reference in their entireties.

### DESCRIPTION

### Technical Field

The disclosure relates to a cooking apparatus with an improved structure.

### Background Art

A cooking apparatus is a device for heating and cooking an object to be cooked, such as food, and that may provide various functions related to cooking, such as heating, defrosting, drying, and sterilizing the object to be cooked. Cooking apparatuses may include cooktops that heat cooking vessels containing food using electricity or gas.

A gas cooktop, which uses gas, is a device known as a gas range that cooks food using heat generated by turning a lever to ignite and burn gas from a small generator.

An electric cooktop, which uses electricity, is an induction cooktop that generates an electromagnetic field in internal coils using electricity, and, according to the law of electromagnetic induction induces eddy currents in the cooking vessel to generate heat, thereby cooking food with the resulting heat.

In the case of cooktops, pollutants such as oil mist, unburned gas, and odors may be generated during the cooking process. A hood may be provided to exhaust air containing such pollutants to the outside.

### DISCLOSURE

### Technical Problem

An embodiment of the present disclosure provides a cooking apparatus with improved ease of use.

An embodiment of the present disclosure provides a cooking apparatus including a hood for drawing in contaminated air generated during cooking.

An embodiment of the present disclosure provides a cooking apparatus capable of minimizing a step with an upper plate by improving the assembly structure of a hood.

Technical tasks to be achieved in the present document are not limited to the technical tasks mentioned above, and other technical tasks not mentioned will be clearly understood by those skilled in the art from the description below.

### Technical Solution

A cooking apparatus according to the spirit of the present disclosure includes a plate including an intake port, an opening/closing device, to be disposed below the plate, configured to move a cover that is moveable to cover or open the intake port, and a holder including an adhesive portion to be between the opening/closing device and the plate such that while the holder is between the opening/closing device and the plate, the adhesive portion is adhered to a bottom surface of the plate.

A cooking apparatus according to the spirit of the present disclosure includes a plate including an intake port to draw in air around a cooking area, and an opening/closing device to be coupled to the plate and configured to move a cover that covers or opens the intake port, the cooking apparatus including a holder including an adhesive portion to be between the opening/closing device and the plate such that while the holder is between the opening/closing device and the plate, the adhesive portion is adhered to a bottom surface of the plate and a fastening portion of the holder is to be coupled to the opening/closing device. The holder may be coupled to the opening/closing device by the fastening portion in a state of being coupled to the bottom surface of the plate by the adhesive portion.

### Advantageous Effects

According to an aspect of the present disclosure, the cooking apparatus with improved ease of use may be provided.

According to an aspect of the present disclosure, the cooking apparatus including the hood that draws in contaminated air generated during cooking may be provided.

According to an aspect of the present disclosure, the assembly structure of the hood may be improved to minimize the step with the upper plate.

According to an aspect of the present disclosure, by directly assembling the hood and the upper plate, the step between the hood and the upper plate may be minimized as the assembly is not affected by assembly tolerances and clearances caused by combination with other components.

The effects to be obtained from the present disclosure are not limited to the effects mentioned above, and other unmentioned effects can be clearly understood by those of ordinary skill in the art to which the present disclosure pertains from the description below.

### DESCRIPTION OF DRAWINGS

FIG. 1 is a perspective view of a cooking apparatus according to an embodiment.

FIG. 2 is a bottom perspective view of the cooking apparatus according to an embodiment.

FIG. 3 is a schematic exploded view of the cooking apparatus according to an embodiment.

FIG. 4 is a view showing a portion of an interior of the cooking apparatus according to an embodiment, FIG. 5 is a schematic cross-sectional view of the cooking apparatus according to an embodiment.

FIG. 6 is a view showing an opening/closing device coupled to a plate of the cooking apparatus according to an embodiment.

FIG. 7 is a view showing a holder coupled to the plate according to an embodiment.

FIG. 8 is a front view showing the holder coupled to the plate according to an embodiment.

FIG. 9 is a partial cross-sectional view showing the holder coupled to the plate according to an embodiment.

FIG. 10 is a perspective view showing the holder and the opening/closing device coupled to the plate according to an embodiment.

FIG. 11 is a view showing the opening/closing device attached to the holder coupled to the plate according to an embodiment.

FIG. 12 is a front view showing the opening/closing device coupled to the plate shown in FIG. 11 according to an embodiment.

FIG. 13 is a view showing the opening/closing device secured to the plate by a fastening portion according to an embodiment.

FIG. 14 is an exploded perspective view showing the opening/closing device fixed to the plate by the fastening portion shown in FIG. 13 according to an embodiment.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

In addition, the terms “portion”, “unit”, “part”, “module” and “member” may be implemented in hardware or software. Depending on embodiments, a plurality of “portions”, “units”, “parts”, “modules” and “members” may be implemented as a single element, or a single “portion”, “unit”, “part”, “module” or “member” may include a plurality of elements.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “has”, “including”, “comprising”, and/or “having” are used in the disclosure, they specify the presence of the specified features, numbers, steps, operations, components, members, or combinations thereof, but do not preclude the presence or addition of one or more other features, numbers, steps, operations, components, members, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

As used in the following description, the terms “front”, “rear”, “left”, “right”, “up”, and “down” are defined based on the drawings, and the shape and position of each element are not limited by these terms. For example, a front may be defined as a +X side, and a rear may be defined as the −X side. For example, based on the drawings, a right may be defined as a +Y side, and a left may be defined as the −Y side. For example, based on the drawings, an upward may be defined as a +Z side, and a downward may be defined as the −Z side.

Hereinafter, embodiments according to the present disclosure will be described in detail with reference to the accompanying drawings.

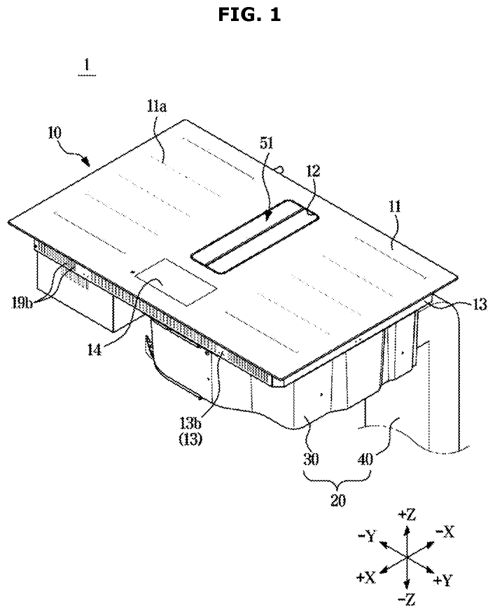

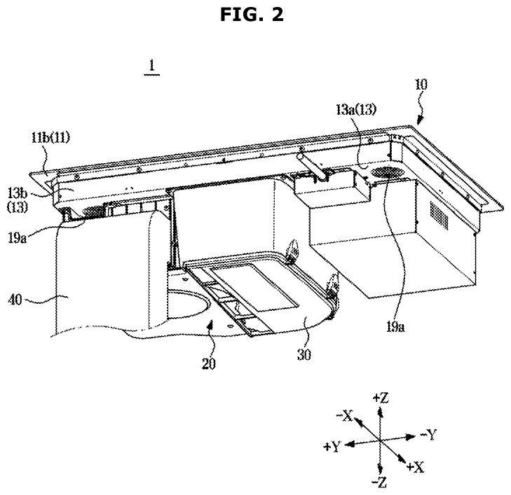

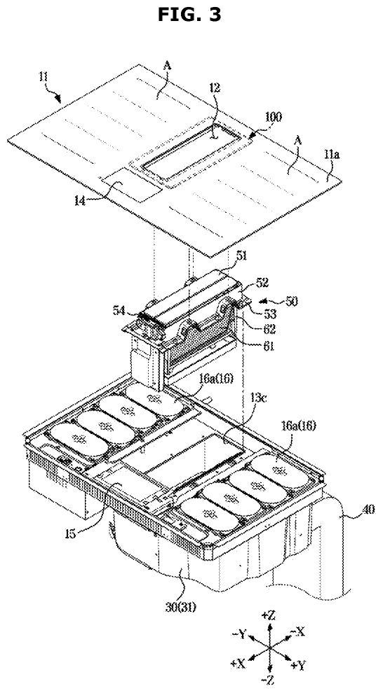

FIG. 1 is a perspective view of a cooking apparatus according to an embodiment, FIG. 2 is a bottom perspective view of the cooking apparatus according to an embodiment, and FIG. 3 is a schematic exploded view of the cooking apparatus according to an embodiment.

As shown in FIGS. 1 to 3, a cooking apparatus 1 may include a cooktop 10. The cooktop 10 may be configured to cook food. The cooktop 10 may be provided to heat food.

The cooktop 10 may include a plate 11 on which a cooking vessel may be placed. The plate 11 may include a top surface 11a. The plate 11 may include a cooking area A on which a cooking vessel may be placed. For example, the plate 11 may have a substantially flat plate shape. For example, the plate 11 may include tempered glass, such as ceramic glass.

The cooktop 10 may include an intake port 12. The intake port 12 may be formed in the plate 11. The intake port 12 may be configured to penetrate the plate 11. For example, the intake port 12 may be positioned substantially at the center of the plate 11. The intake port 12 may be configured to draw in air from around the cooktop 10. The intake port 12 may draw in air containing pollutants generated during the cooking process. Pollutants may include harmful gases, combustion gases, fine dust, oil mist, hot air, and/or odors generated during cooking.

The cooktop 10 may include a user interface 14 provided on the plate 11. The user interface 14 may be configured to receive commands from a user. The user interface 14 may be configured to display various types of information regarding the cooking apparatus 1.

The cooktop 10 may include a case 13. The case 13 may be provided below the plate 11. The case 13 may be provided to be coupled to the lower portion of the plate 11. The case 13 may have a shape with a substantially open top. For example, the case 13 may include a bottom portion 13a and a side portion 13b extending upwardly from the bottom portion 13a.

The case 13 may be configured to accommodate various components constituting the cooktop 10. The case 13 may be configured to accommodate electrical components.

The cooktop 10 may include a display assembly 15. The display assembly 15 may be configured to implement the user interface 14. The display assembly 15 may be disposed to correspond to the user interface 14. For example, the display assembly 15 may be provided as a printed board assembly (PBA) including a display panel, switching elements, integrated circuit elements, or the like, and a printed circuit board (PCB) on which these are installed.

The cooktop 10 may include a heating portion 16. The heating portion 16 may be disposed to heat the plate 11. For example, the heating portion 16 may include a coil 16a. A current whose magnitude varies over time may be applied to the coil 16a. As current is applied to the coil 16a, a magnetic field may be formed around the coil 16a. As the current applied to the coil 16a varies, the magnetic field formed around the coil 16a may also vary. Eddy currents resulting from the variation in the magnetic field may flow on the surface of the cooking vessel in contact with the plate 11, thereby heating the cooking vessel.

While the cooktop 10 is shown in the drawings as an induction cooktop, which is an electric cooktop, the present disclosure is not limited thereto. The type of the cooktop 10 is not limited as long as the cooktop 10 may heat a cooking vessel. For example, the cooktop may be provided as a gas range, a highlight cooktop, a hybrid cooktop, or an oven.

The cooktop 10 may include a PBA (not shown). The PBA may be configured to supply a drive current to the heating portion 16. The PBA may be configured to implement circuitry for an operation of the heating portion 16. The PBA may include various elements and/or circuits for supplying the drive current to the heating portion 16.

The cooktop 10 may include a fan (not shown). The fan may be provided for heat dissipation inside the case 13. The fan may blow outside air to lower the temperature of the PBA and/or the display assembly 15. The fan may draw in outside air. The fan may exhaust air that has flowed through an interior of the case 13. The outside air drawn into the case 13 via the fan may cool the interior of the case 13 and then be discharged to the exterior of the case 13.

The case 13 may be provided with an intake hole 19a and a discharge hole 19b. For example, the intake hole 19a may be formed in the bottom portion 13a of the case 13. For example, the discharge hole 19b may be formed in the side portion 13b of the case 13. Outside air may be drawn into the interior of the case 13 through the intake hole 19a by a blowing force of the fan 18 and then discharged to the exterior of the case 13 through the discharge hole 19b. Although the drawings show that the intake hole 19a and the discharge hole 19b are each formed in a plurality, the present disclosure is not limited thereto. There is no limitation on the respective numbers of intake holes 19a and discharge holes 19b.

The cooking apparatus 1 may include a hood 20. The hood 20 may be configured to allow air entering through the intake port 12 to flow. The hood 20 may be configured to guide the air entering through the intake port 12. The hood 20 may be configured to discharge or circulate the air entering through the intake port 12. The hood 20 may discharge the air entering through the intake port 12 to the outside of the space (e.g., indoors) where the cooking apparatus 1 is installed. The hood 20 may recirculate the air drawn in through the intake port 12 back into the space (e.g., indoors) where the cooking apparatus 1 is installed. In summary, the hood 20 may guide the air drawn in through the intake port 12 to the outdoors or indoors. As will be described later, at least one filter 61 may be provided inside the hood 20, and the air flowing through the hood 20 may be filtered by passing through the at least one filter 61. The air passing through the at least one filter 61 may be discharged to the outdoors or introduced indoors by the hood 20.

The hood 20 may be disposed below the plate 11. The hood 20 may be disposed below at least a portion of the cooktop 10. The hood 20 may be disposed below the bottom portion 13a of the case 13. However, the present disclosure is not limited thereto, and the cooktop 10 and the hood 20 may be integrally formed.

By disposing the hood 20 below the cooktop 10, an upper space where the cooking apparatus 1 is installed may be secured. Since the upper portion of the cooking apparatus 1 is provided as an empty space, a cooking area may be secured and the cooking environment may be improved.

The chamber housing 30 may be configured to accommodate air flowing in through the intake port 12. The chamber housing 30 may be configured to form a chamber 31 through which air may flow. The chamber may include a flow path for guiding air into the space provided inside the chamber housing 30. The air entering through the intake port 12 may be guided by a frame 52 and flow into the chamber housing 30.

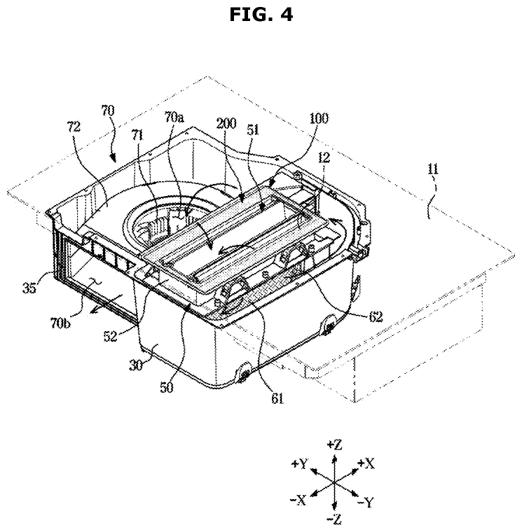

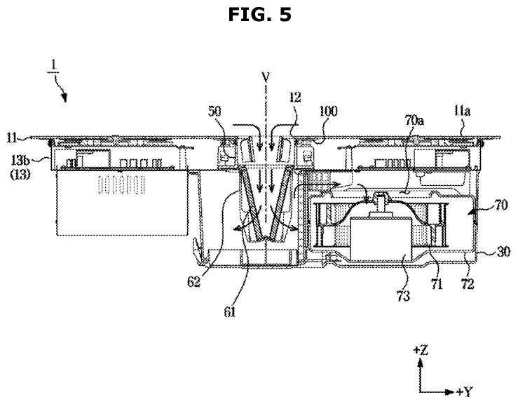

Various components may be disposed in the chamber 31. For example, at least one filter 61 may be disposed in the chamber 31. For example, a fan device 70 (not shown) may be disposed in the chamber 31. The fan device 70 may be configured to force air to flow. The fan device 70 may include a fan 71 configured to generate an intake force. The fan 71 may generate an intake force. Air may flow into the interior of the cooking apparatus 1 through the intake port 12 by the intake force of the fan 71 (see FIG. 4).

The fan device 70 may include a fan motor 73. The fan motor 73 may be configured to drive the fan 71. The fan motor 73 may provide rotational force to the fan 71.

The fan device 70 may include a fan housing 72. The fan housing 72 may be configured to cover the fan 71 and the fan motor 73. The fan housing 72 may be configured to accommodate the fan 71 and the fan motor 73 (see FIG. 4).

The chamber housing 30 may be configured to connect the cooktop 10 and a duct 40. The chamber housing 30 may guide the air drawn in through the intake port 12 into the duct 40.

The hood 20 may include the duct 40. The duct 40 may receive the air discharged from the chamber housing 30. The duct 40 may guide the air discharged from the chamber housing 30 to the outside or to the space where the cooking apparatus 1 is installed. For example, one end of the duct 40 may communicate with the outdoors or indoors. The duct 40 may discharge the air, which is drawn in through the intake port 12 and then filtered through at least one filter 61, to the outdoors or recirculate the air back indoors. Although the drawings show that the chamber housing 30 and the duct 40 as separate configurations, the present disclosure is not limited thereto. The chamber housing 30 and the duct 40 may be provided as an integral configuration due to various factors, such as the type of the cooktop 10 and the installation space.

The cooking apparatus 1 may include the filter 61. At least one or more filters 61 may be provided. The at least one or more filters 61 may be provided on a lower side of the intake port 12. The at least one or more filters 61 may be mounted by a filter bracket 62. The at least one or more filters 61 may be configured to filter the air drawn in through the intake port 12. For example, the filter 61 may include a first filter and a second filter. For example, the first filter may be a grease filter for removing oil particles contained in the air. For example, the second filter may be a deodorizing filter for removing odor particles contained in the air.

The filter 61 and the filter bracket 62 may be disposed inside the hood 20. For example, the filter 61 and the filter bracket 62 may be disposed in the chamber 31. The filter 61 may be arranged such that an upper surface thereof is open toward the intake port 12. The filter 61 may be mounted on both sides of the filter bracket 62. Two filters 61 may be arranged to face each other. Two filters 61 may be arranged to face each other and open toward the intake port 12 so that air entering through the intake port 12 may be guided to the filters 61. In the present embodiment, an example where two filters are arranged to face each other on both sides of the filter bracket is shown, but the present disclosure is not limited thereto. For example, the number of filters may be varied depending on the size and shape of the filter bracket.

The upper surface of the filter bracket 62 may be open toward the intake port 12. With such a configuration, the filter bracket 62 may guide the air entering through the intake port 12 to the filters 61.

The cooking apparatus 1 may include a cover 51. The cover 51 may be configured to cover or open the intake port 12. The cover 51 may be configured to be movable to cover or open the intake port 12. The cover 51 may be configured to be rotatable to cover or open the intake port 12.

The cover 51 of the cooking apparatus 1 may be configured to be able to open the intake port 12. Air may flow into the interior of the cooktop 10 through the intake port 12 opened by the cover 51. The air flowing in through the intake port 12 may flow to the hood 20. The air flowing in through the intake port 12 may flow to the chamber housing 30. The air flowing into the chamber housing 30 may pass through the filter 61. The air passing through the filter 61 may flow to the fan device, and the air passing through the fan device may flow into the duct 40. The air flowing into the duct 40 may be discharged to outdoors or circulated indoors.

The cover 51 may be formed to have a size corresponding to the intake port 12. At least one or more covers 51 may be provided. In the present embodiment, an example where two covers 51 are arranged along a substantially horizontal direction (Y direction) is shown, but the present disclosure is not limited thereto. For example, at least one or three or more covers may be formed.

The cover 51 may be detachably coupled to an opening/closing device 50. The cover 51 may be configured to cover or open the intake port 12 by the opening/closing device 50. The cover 51 may be detachably coupled via a connecting member 54 of the opening/closing device 50. The cover 51 may be connected to the connecting member 54 and configured to cover the intake port 12 or open the intake port 12. The cover 51 may be configured to rotate together with the connecting member 54. The cover 51 connected by the connecting member 54 may be configured to be rotated by the opening/closing device 50.

The cooking apparatus 1 may include the opening/closing device 50. The opening/closing device 50 may be configured to transmit a drive force to the cover 51. The opening/closing device 50 may be configured to move the cover 51. The opening/closing device 50 may be configured to rotate the cover 51. At least a portion of the opening/closing device 50 may be disposed inside the cooktop 10, and another portion of the opening/closing device 50 may be disposed inside the hood 20. For example, the cooktop 10 may be provided with an opening/closing device installation portion 13c formed by penetrating at least a portion of the case 13 so that at least a portion of the opening/closing device 50 is disposed therein. For example, at least a portion of the opening/closing device 50 may be disposed inside the case 13, and another portion of the opening/closing device 50 may be disposed inside the chamber housing 30. However, the present disclosure is not limited thereto, and the opening/closing device 50 may be provided in various locations as long as it is capable of driving the cover 51.

The opening/closing device 50 may include the frame 52. The frame 52 may be configured to guide the air entering through the intake port 12 to the hood 20. The frame 52 may have a substantially open upper and lower shape. The frame 52 may form a flow path (not shown) for guiding the air entering through the intake port 12 to the hood 20. The flow path may be provided inside the cooktop 10. The frame 52 may include side walls for forming the flow path. The frame 52 may be provided with a flange 53 on which a fastening portion 120 is formed for coupling with a holder 100 configured to couple the opening/closing device 50 to the plate 11. The flange 53 may be formed by extending from an outer circumference of the side walls of the frame 52. The holder 100 and the fastening portion 120 of the frame 52 will be described in detail later.

The frame 52 may be mounted on the cooktop 10. For example, the frame 52 may be secured to the plate 11 and/or the bottom portion 13a of the case 13. Various components constituting the opening/closing device 50 may be mounted to the frame 52. The frame 52 may be configured to support various components constituting the opening/closing device 50. For example, a motor, a cam, a connecting rod, a moving member, a guide link, a spring, and/or a switch of the opening/closing device 50 (not shown) may be mounted to the frame 52.

Although the frame 52 is described above as being one configuration of the opening/closing device 50, the present disclosure is not limited thereto. The frame 52 may be provided as a separate configuration from the opening/closing device 50.

The cooking apparatus 1 may include the holder 100 provided between the opening/closing device 50 and the plate 11. The holder 100 may be coupled to the plate 11 via an adhesive portion 200. The coupling structure between the holder 100 and the plate 11 will be described later.

FIG. 4 is a view showing a portion of an interior of the cooking apparatus according to an embodiment, and FIG. 5 is a schematic cross-sectional view of the cooking apparatus according to an embodiment.

As shown in FIGS. 4 to 5, the cooking apparatus 1 may include the cover 51. The cover 51 may be configured to cover or open the intake port 12. The cover 51 may be configured to be movable to cover or open the intake port 12. The cover 51 may be configured to be rotatable to cover or open the intake port 12.

Air may flow into the cooktop 10 through the intake port 12 opened by the cover 51. The air flowing in through the intake port 12 may flow to the hood 20. The air flowing in through the intake port 12 may flow to the chamber housing 30. For example, the air flowing in through the intake port 12 may be guided by the frame 52 and flow to the chamber housing 30. One side of the frame 52 may be in communication with the intake port 12, and the other side of the frame 52 may be in communication with the chamber housing 30. The air flowing into the chamber housing 30 may pass through the filters 61. The air passing through the filters 61 may flow to an intake side 70a of the fan device 70. The air flowing into the fan device 70 may flow out through a discharge side 70b of the fan device 70. The discharge side 70b of the fan device 70 may be open toward a chamber discharge portion 35 of the chamber housing 30. The air discharged from the fan device 70 may flow out of the chamber housing 30 through the chamber discharge portion 35. The air flowing out of the chamber housing 30 may flow into the duct 40. The air flowing into the duct 40 may be discharged to outdoors or circulated indoors.

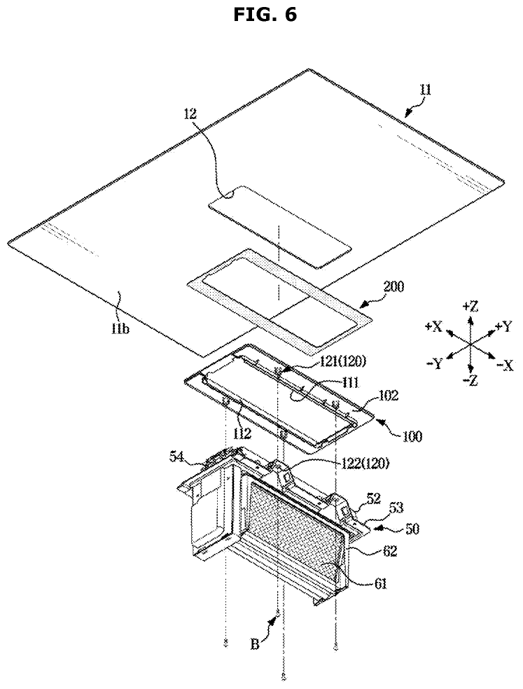

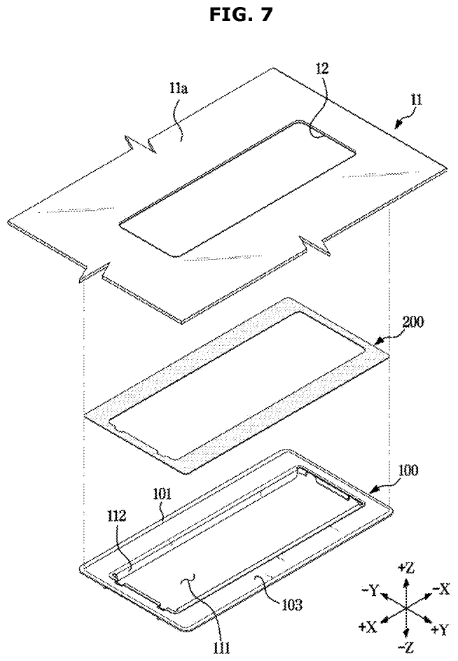

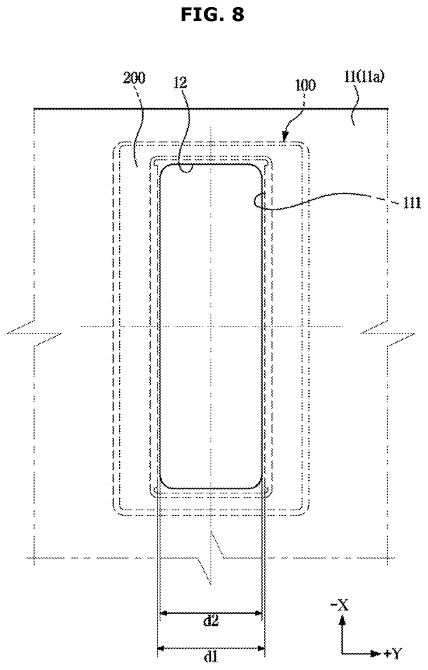

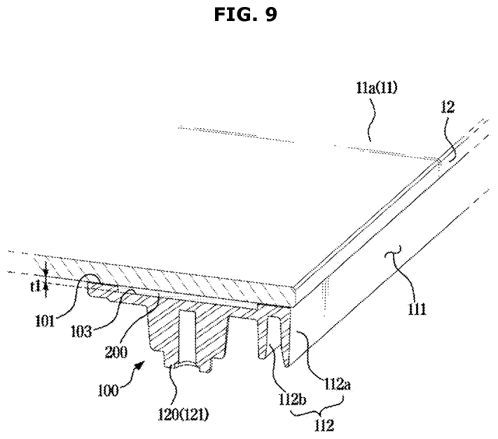

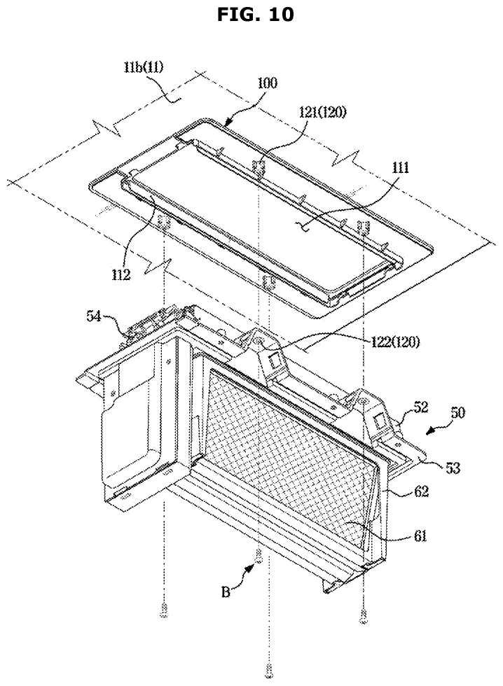

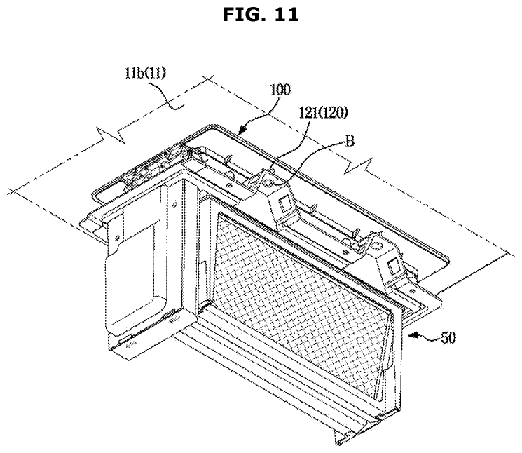

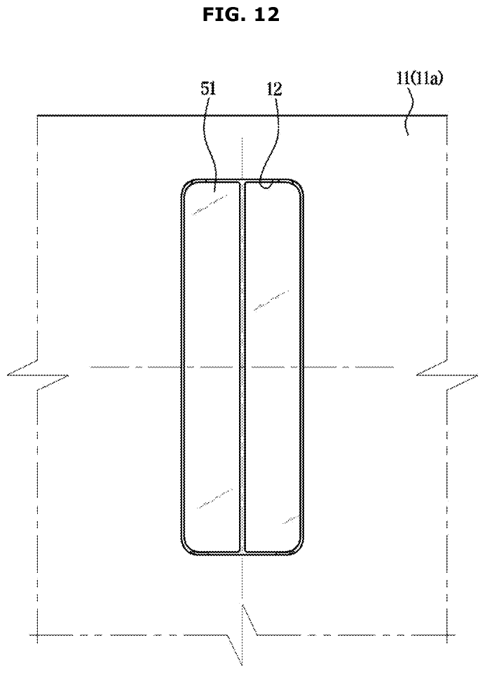

FIG. 6 is a view showing an opening/closing device coupled to a plate of the cooking apparatus according to an embodiment, FIG. 7 is a view showing a holder coupled to the plate according to an embodiment, FIG. 8 is a front view showing the holder coupled to the plate according to an embodiment, FIG. 9 is a partial cross-sectional view showing the holder coupled to the plate according to an embodiment, FIG. 10 is a perspective view showing the holder and the opening/closing device coupled to the plate according to an embodiment, FIG. 11 is a view showing the opening/closing device attached to the holder coupled to the plate according to an embodiment, and FIG. 12 is a front view showing the opening/closing device coupled to the plate shown in FIG. 10. Hereinafter, redundant descriptions regarding the aforementioned description will be omitted.

As shown in FIGS. 6 to 12, the cooking apparatus 1 may include the plate 11 having the intake port 12, the opening/closing device 50 disposed below the plate 11 and configured to move the cover 51 that is movably configured to cover or open the intake port 12, and the holder 100 provided between the plate 11 and the opening/closing device 50.

The holder 100 may include the adhesive portion 200 configured to be adhered to a bottom surface 11b of the plate 11. The adhesive portion 200 may include at least one of an adhesive tape, a double-sided tape, and silicone. The adhesive portion 200 may be configured to secure between the holder 100 and the plate 11 by tightly adhering a holder upper surface 101 of the holder 100 and the bottom surface 11b of the plate 11.

The holder 100 may be provided in a plate shape to be contactable with the bottom surface 11b of the plate 11. The holder upper surface 101 of the holder 100 may be provided in a plate shape to be contactable with the bottom surface 11b of the plate 11. The holder upper surface 101 of the holder 100 may be provided in a flat shape to be tightly adhered to the bottom surface 11b of the plate 11. The holder 100 may include an opening 111 corresponding to the intake port 12. The holder 100 may include the opening 111 formed penetrating its center so as to correspond to the intake port 12 of the plate 11. The opening 111 of the holder 100 may be formed to correspond to the intake port 12 of the plate 11. For example, the opening 111 of the holder 100 may be formed in a rectangular shape to correspond to the intake port 12. In the present embodiment, the opening 111 of the holder 100 is shown as having a rectangular shape corresponding to the shape of the intake port 12 as an example, but the present disclosure is not limited thereto. The opening of the holder may be modified according to the shape of the intake port.

The opening 111 of the holder 100 may be formed larger than the intake port 12 of the plate 11. The opening 111 of the holder 100 may be formed with a first width d1. The first width d1 of the holder 100 may be formed larger than a second width d2 of the intake port 12.

The holder 100 may include an adhesive portion installation portion 103 for providing the adhesive portion 200. The adhesive portion installation portion 103 may be provided on the holder upper surface 101. The adhesive portion installation portion 103 may be provided on at least a portion of the holder upper surface 101. The adhesive portion installation portion 103 may be provided around the opening 111 of the holder 100. The adhesive portion installation portion 103 may be formed by being recessed into the holder upper surface 101 so as to be tightly adhered to the bottom surface 11b of the plate 11 by the adhesive portion 200. The adhesive portion installation portion 103 may be provided such that the adhesive portion 200 is sandwiched between the adhesive portion installation portion 103 and the bottom surface 11b of the plate 11 while maintaining close contact. The adhesive portion installation portion 103 may be formed with a first thickness t1. The adhesive portion 200 may be tightly adhered to the bottom surface 11b of the plate 11 with a predetermined thickness via the adhesive portion installation portion 103.

The holder 100 may include a guide 112 provided at the opening 111. The guide 112 may be formed extending downward from the opening 111. The guide 112 may be formed extending downward from the opening 111. The guide 112 may be arranged in a rectangular shape to correspond to the shape of the opening 111.

The guide 112 may include a first guide 112a forming the opening 111 and a second guide 112b disposed on an outer side of the first guide 112a. The first guide 112a may form the opening 111 of the holder 100, thereby being configured to guide the air moving through the intake port 12 of the plate 11. The second guide 112b may be disposed around an outer circumference of the first guide 112a. The second guide 112b may be formed by extending downward while being spaced apart from the first guide 112a by a certain interval. The second guide 112b may be configured to increase the rigidity of the holder 100. The second guide 112b may be configured to improve the durability of the holder 100. The first guide 112a and the second guide 112b may improve the durability of the holder 100 attached to the bottom surface 11b of the plate 11 by the adhesive portion 200.

The holder 100 may include the fastening portion 120. The fastening portion 120 may be configured to secure the holder 100 and the opening/closing device 50. The fastening portion 120 may be provided on at least one of the holder 100 and the opening/closing device 50. The fastening portion 120 may be provided such that the holder 100 and the opening/closing device 50 are coupled to each other.

The fastening portion 120 may include a first fastening portion 121 provided on a holder rear surface 102 of the holder 100. The first fastening portion 121 may be formed protruding from the holder rear surface 102. The first fastening portion 121 may be formed to protrude from the holder rear surface 102 and may have a threaded hole formed therein.

The fastening portion 120 may include a second fastening portion 122 provided on the frame 52 of the opening/closing device 50. The second fastening portion 122 may be provided on the flange 53 of the frame 52 to correspond to the first fastening portion 121. The second fastening portion 122 may include a hole formed in the flange 53. The first fastening portion 121 and the second fastening portion 122 may be configured to correspond to each other. The first fastening portion 121 and the second fastening portion 122 may be coupled through a fastening member B. The fastening member B configured to couple the first fastening portion 121 and the second fastening portion 122 may include a screw. While the drawings show that the first fastening portion 121 is a protrusion in which a threaded hole is formed therein, the second fastening portion is a hole through which the screw passes, and the screw, which is the fastening member, passes through the second fastening portion to be penetrated into the first fastening portion as an example, the present disclosure is not limited thereto. For example, the first fastening portion, the second fastening portion, and the fastening member may be configured to couple and fix the holder, the opening/closing member, and/or the flange.

A procedure for assembling the opening/closing device 50 configured to move the cover 51 that covers or opens the intake port 12 to the plate 11 provided with the intake port 12 to draw in the air around the cooking area A will be described.

The plate 11 of the cooking apparatus 1 may be secured by attaching the holder 100 to its bottom surface 11b using the adhesive portion 200, such as a double-sided tape and/or silicone. The plate 11 and the holder 100 may be securely adhered by being in close contact with each other via the adhesive portion 200. The holder 100 may be provided such that the opening 111 is positioned at the intake port 12 on the bottom surface 11b of the plate 11.

Once the holder 100 is secured to the plate 11, the plate 11 may be turned over so that the holder 100 faces upward.

In a state where the plate 11 is turned over, the opening/closing device 50 may be secured to the holder 100. The second fastening portion 122 of the opening/closing device 50 may be positioned on the first fastening portion 121 of the holder 100, and the first fastening portion 121 and the second fastening portion 122 may be secured by passing the fastening member B therethrough.

As such, in a state where the holder 100 is secured to the plate 11, the opening/closing device 50 may be secured to the holder 100, so that the opening/closing device 50 may be directly assembled around the intake port 12 of the plate 11 via the holder 100. Thus, a gap and step (e.g., height difference) between the opening/closing device 50 and the plate 11 may be minimized, as the assembly is not affected by assembly tolerances or clearances resulting from combinations with other components.

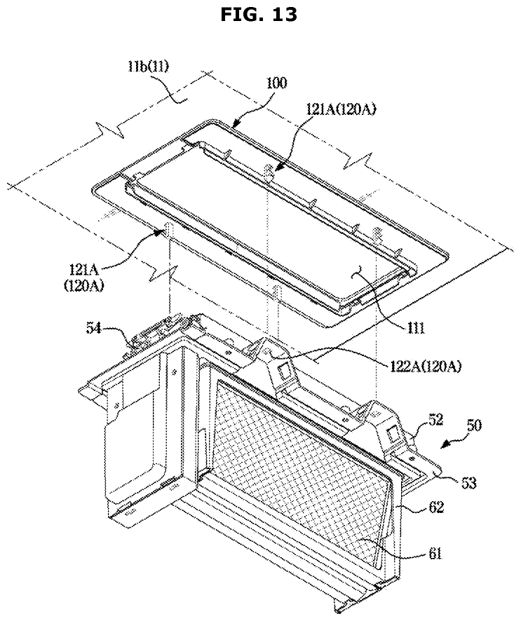

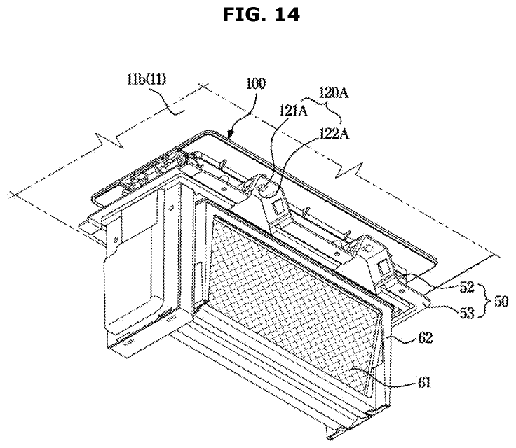

FIG. 13 is a view showing the opening/closing device secured to the plate by a fastening portion according to an embodiment, and FIG. 14 is an exploded perspective view showing the opening/closing device secured to the plate by the fastening portion shown in FIG. 13. Hereinafter, redundant descriptions regarding the aforementioned description will be omitted.

As shown in FIGS. 13 to 14, the cooking apparatus may include the holder 100 provided between the plate 11 and the opening/closing device 50.

The holder 100 may be configured to secure the opening/closing device 50 to the plate 11. The holder 100 may include a fastening portion 120A. The fastening portion 120A may be provided on at least one of the holder 100 and the opening/closing device 50. The fastening portion 120A may be provided such that the holder 100 and the opening/closing device 50 are coupled to each other.

The fastening portion 120A may include a first fastening portion 121A provided on the holder rear surface 102 of the holder 100. The first fastening portion 121A may be formed protruding from the holder rear surface 102. The first fastening portion 121A may include a hook formed protruding from the holder rear surface 102.

The fastening portion 120A may include a second fastening portion 122A provided on the frame 52 of the opening/closing device 50. The second fastening portion 122A may be configured to correspond to the first fastening portion 121A. The second fastening portion 122A may include a hook hole formed in the flange 53. The first fastening portion 121A and the second fastening portion 122A may be configured to correspond to each other. The first fastening portion 121A may be inserted into and coupled to the second fastening portion 122A. In the present embodiment, an example where the fastening portion for securing the holder and the opening/closing device is a hook is shown, but the present disclosure is not limited thereto. For example, the first fastening portion and the second fastening portion may be configured to couple and secure the holder, the opening/closing member, and/or the flange.

The cooking apparatus 1 according to an embodiment may include the plate 11 including the intake port 12; the opening/closing device 50 disposed below the plate 11 and configured to move the cover 51 movably provided to cover or open the intake port 12; and the holder 100 provided between the opening/closing device 50 and the plate 11, wherein the holder 100 may include the adhesive portion 200 to be adhered to a bottom surface of the plate 11. According to the present disclosure, the step with the upper plate may be minimized by improving the assembly structure of the hood.

The adhesive portion 200 may include at least one of an adhesive member, a double-sided tape, and silicone, the adhesive portion 200 may be provided between an upper surface of the holder and the bottom surface of the plate, and the adhesive portion may be provided around the intake port.

The holder 100 may be provided in a plate shape to be contactable with the plate 11, and the opening 111 may be formed at a center to correspond to the intake port 12. The holder may include the adhesive portion installation portion 103 provided around the opening where the adhesive portion is provided. The holder may include the fastening portion 120 configured to be coupled to the opening/closing device. The fastening portion 120 may include the first fastening portion 121 provided on a bottom surface of the holder, and the second fastening portion 122 provided on the upper surface of the opening/closing device 50 to correspond to the first fastening portion 121. The fastening portion may include at least one of a hook and a screw. The holder may include the guide 112 formed to extend downward from the opening. Thus, by directly assembling the hood and the upper plate, the step between the hood and the upper plate may be minimized because it is not affected by assembly tolerances and clearances caused by combination with other components.

In the cooking apparatus 1 according to an embodiment comprising the plate 11 including the intake port 12 to draw in air around the cooking area A, and the opening/closing device 50 coupled to the plate 11 and configured to move the cover 51 that covers or opens the intake port 12, the cooking apparatus may include the holder 100 provided between the opening/closing device 50 and the plate 11, the holder 100 may include the adhesive portion 200 to be adhered to a bottom surface of the plate 11 and the fastening portion 120 to be coupled to the opening/closing device, and the holder 100 may be coupled to the opening/closing device 50 by the fastening portion 120 in a state of being coupled to the bottom surface 11b of the plate by the adhesive portion 200. According to the present disclosure, the step with the upper plate may be minimized by improving the assembly structure of the hood.

The adhesive portion 200 may include at least one of an adhesive member, a double-sided tape, and silicone. The adhesive portion may be provided around the intake port 12.

The holder may be provided in a plate shape to be contactable with the plate, and the opening 111 may be formed at a center thereof to correspond to the intake port. The holder may include the adhesive portion installation portion 103 provided around the opening where the adhesive portion is provided. The fastening portion may include the first fastening portion 121 provided on the bottom surface of the holder, and the second fastening portion 122 provided on the upper surface of the opening/closing device to correspond to the first fastening portion 121. The fastening portion may include at least one of a hook and a screw. The holder may include the guide 112 extending downward from the opening.

While the cooking apparatus has been particularly described above focusing on specific shapes and orientations with reference to the accompanying drawings, it should be understood that a person skilled in the art may make various modifications and changes, and such modifications and changes should be interpreted as falling within the scope of the disclosure.

1. A cooking apparatus, comprising:
a plate including an intake port;
an opening/closing device, to be disposed below the plate, configured to move a cover that is moveable to cover or open the intake port; and
a holder including an adhesive portion to be between the opening/closing device and the plate such that while the holder is between the opening/closing device and the plate, the adhesive portion is adhered to a bottom surface of the plate.

2. The cooking apparatus of claim 1, wherein the adhesive portion comprises at least one of an adhesive member, a double-sided tape, and silicone.

3. The cooking apparatus of claim 1, wherein the adhesive portion is provided between an upper surface of the holder and the bottom surface of the plate.

4. The cooking apparatus of claim 1, wherein the adhesive portion is provided around the intake port.

5. The cooking apparatus of claim 1, wherein the holder is provided in a plate shape to be contactable with the plate, and an opening is formed at a center thereof to correspond to the intake port.

6. The cooking apparatus of claim 5, wherein the holder comprises an adhesive portion installation portion provided around the opening where the adhesive portion is provided.

7. The cooking apparatus of claim 1, wherein the holder comprises a fastening portion configured to be coupled to the opening/closing device.

8. The cooking apparatus of claim 7, wherein the fastening portion comprises:
a first fastening portion provided on a bottom surface of the holder, and
a second fastening portion provided on an upper surface of the opening/closing device to correspond to the first fastening portion.

9. The cooking apparatus of claim 7, wherein the fastening portion comprises at least one of a hook and a screw.

10. The cooking apparatus of claim 5, wherein the holder comprises a guide formed to extend downward from the opening.
